(19) United States
(12) Patent Application Publication
(10) Pub. No.: US 2019/0092180 A1
(43) Pub. Date: Mar. 28, 2019

(54) METHOD OF OPERATING AN ELECTRIC VEHICLE CHARGING AND TRACTION SYSTEM

(71) Applicant: Zhengmao ZHU, Fremont, CA (US)

(72) Inventor: Zhengmao ZHU, Fremont, CA (US)

(21) Appl. No.: 15/717,679

(22) Filed: Sep. 27, 2017

(51) Int. Cl. B60L 11/18; B60L 15/00

(52) U.S. Cl. CPC B60L 11/1816; B60L 11/1803; B60L 15/00

(57) ABSTRACT

In an electric vehicle charging and traction system with an inverter configured to be coupled to at most one DC power source and provide AC power, a first motor coupled to the inverter, a second motor coupled to the first motor, a converter coupled to the second motor and to a rechargeable DC power unit, and a switching mechanism configured to control coupling or decoupling of the inverter: in charging mode, decouple the inverter from the rechargeable DC power unit, couple the inverter to a second DC power source, and run the first motor at speed in a first direction and the second motor with negative torque to generate current; and in traction mode, decouple the inverter from the second DC power source, couple the inverter to the rechargeable DC power unit, and run the first and second motors with nonzero torque in a same torque direction.

### RELATED APPLICATIONS

This application relates to U.S. patent application Ser. No. ______ (Attorney Docket No. 118998-5002-US), filed ______, entitled “Electric Vehicle Charging and Traction System,” which is incorporated by reference herein in its entirety.

### TECHNICAL FIELD

The disclosed embodiments relate generally to electric vehicle charging and traction systems, including but not limited to onboard combined charging and traction systems for electric vehicles such as passenger, commercial, and special-purpose electric vehicles, and associated operating methods.

### BACKGROUND

Electric vehicles are becoming increasingly prevalent, accounting for a growing share of vehicles in the market. However, the availability of electric vehicle charging stations (or the lack thereof) and the limited speeds at which electric vehicles can be charged present barriers to more widespread adoption of electric vehicles. Generally, two types of electric vehicle charging stations (sometimes called conductive charging systems, or electric vehicle supply equipment (EVSE)) are used: alternating current-based charging stations (AC EVSE), and direct current-based charging stations (DC EVSE). The use of AC EVSE typically offers more limited charging capabilities, such as slower charging speeds, due to the need for an onboard system installed in or on the electric vehicle to convert AC power from an electrical grid or power grid into the DC power needed for charging the DC energy storage units of the vehicle. The use of DC EVSE typically offers greater charging capabilities, such as higher power transmission and faster charging speeds, than AC EVSE. Moreover, directly providing DC power to the vehicle, rather than AC power, eliminates the need for the onboard AC-DC conversion system. However, the cost of implementing DC EVSE is significantly higher than that of AC EVSE, a factor that limits the availability of DC EVSE.

Accordingly, there is a need for a lower cost, onboard charging system that is capable of high power transmission. One way to reduce the cost of a charging system is to reduce the number of components required, and/or by incorporating components that serve multiple purposes. Moreover, in some circumstances, the design of a charging system that is to be installed on an ordinary passenger car is subject to constraints such as size limits, weight limits, and vehicle emissions standards. On the other hand, some electric vehicles, such as special-purpose vehicles for commercial or construction environments, are larger and can tolerate larger sizes and heavier weights of onboard charging systems, and may not be subject to the same emissions restrictions. Thus, systems and methods are provided herein for lower cost, onboard combined charging and traction systems for electric vehicles, including special-purpose electric vehicles. Such systems and methods may complement or replace conventional methods for electric vehicle charging.

### SUMMARY

The above deficiencies and other problems associated with electric vehicle charging systems are reduced or eliminated by the systems and methods disclosed herein. Various embodiments of systems, methods, and devices within the scope of the appended claims each have several aspects, no single one of which is solely responsible for the attributes describe herein. Without limiting the scope of the appended claims, after considering this disclosure, and particularly after considering the section entitled “Detailed Description,” one will understand how the aspects of various embodiments are used to provide improved onboard electric vehicle charging systems with combined charging and traction capabilities.

In accordance with some embodiments, an electric vehicle charging and drive system includes: an inverter, having an input terminal configured to receive DC power, and having an output terminal configured to provide AC power; a first motor coupled to the output terminal of the first inverter; a second motor coupled to the first motor; a converter, having one or more AC terminals coupled to the second motor, and having a positive DC terminal and a negative DC terminal coupled to a rechargeable DC power unit; and a switching mechanism configured to control coupling or decoupling of the input terminal of the first inverter with at most one of a plurality of DC power sources. The plurality of DC power sources includes the rechargeable DC power unit.

In some embodiments, when the input terminal of the inverter is coupled via the switching mechanism to a DC power source (of the plurality of DC power sources) distinct from the rechargeable DC power unit, the system is configured to operate in a first mode of operation. In the first mode of operation: the inverter is configured to receive DC power from the DC power source and provide AC power to turn the first motor and the second motor coupled to the first motor; the second motor is configured to provide AC power to the converter via the one or more AC terminals; and the converter is configured to convert the AC power from the second motor to DC power to charge the rechargeable DC power unit. When the input of the inverter is coupled via the switching mechanism to the rechargeable DC power unit, the system is configured to operate in a second mode of operation. In the second mode of operation: the inverter and the converter are configured to receive DC power from the rechargeable DC power unit and provide AC power to turn the first motor and the second motor coupled to the first motor.

In some embodiments, the first motor and the second motor are distinct motors that are mechanically coupled.

In some embodiments, the first motor and the second motor are respective portions of a single motor.

In some embodiments, the first mode of operation of the system is a charging mode.

In some embodiments, the second mode of operation of the system is a traction mode.

In some embodiments, the DC power source includes a rectifier configured to receive, as an input, AC power from an external power grid and convert the AC power from the external power grid to the DC power provided by an output of the rectifier to the input of the inverter.

In some embodiments, the AC power provided by the inverter and the AC power provided by or to the converter includes poly-phase AC power.

In some embodiments, the system includes a clutch or other type of rotary engagement and disengagement device such as synchronizer and a plurality of wheels. The clutch or such device is configured to control coupling or decoupling of the first motor and the second motor with the plurality of wheels.

### BRIEF DESCRIPTION OF THE DRAWINGS

So that the present disclosure can be understood in greater detail, a more particular description may be had by reference to the features of various embodiments, some of which are illustrated in the appended drawings. The appended drawings, however, merely illustrate the more pertinent features of the present disclosure and are therefore not to be considered limiting, for the description may admit to other effective features.

FIG. 1 is a schematic diagram illustrating an example combined charging and traction system, in accordance with some embodiments.

FIGS. 2A-2C illustrate example configurations of motors in a combined charging and traction system, in accordance with some embodiments.

FIG. 3 is a block diagram illustrating example control circuitry in a combined charging and traction system, in accordance with some embodiments.

FIG. 4 is a conceptual flowchart representation of a method of controlling charging and traction in a combined charging and traction system, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all the components of a given system, method or device. Finally, like reference numerals may be used to denote like features throughout the specification and figures.

### DETAILED DESCRIPTION

Reference will now be made in detail to embodiments, examples of which are illustrated in the accompanying drawings. In the following detailed description, numerous non-limiting specific details are set forth to assist in understanding the subject matter presented herein. It will be apparent, however, to one of ordinary skill in the art that various alternatives may be used without departing from the scope of the claims, and that the subject matter may be practiced without these specific details. In other instances, well-known methods, procedures, components, circuits, and systems have not been described in detail so as not to unnecessarily obscure aspects of the embodiments.

It will also be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, without changing the meaning of the description, so long as all occurrences of the “first contact” are renamed consistently and all occurrences of the second contact are renamed consistently. The first contact and the second contact are both contacts, but they are not the same contact, unless the context clearly indicates otherwise.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the phrase “at least one of A, B and C” is to be construed to require one or more of the listed items, and this phase reads on a single instance of A alone, a single instance of B alone, or a single instance of C alone, while also encompassing combinations of the listed items such as “one or more of A and one or more of B without any of C,” and the like.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

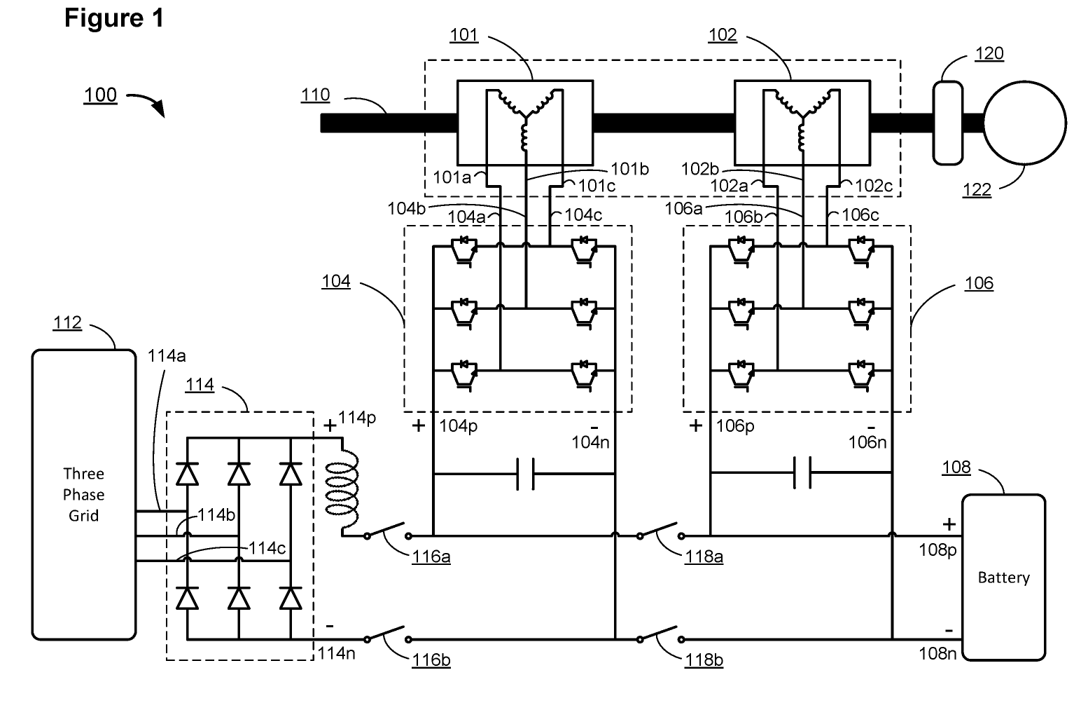

FIG. 1 is a schematic diagram illustrating combined charging and traction system 100, in accordance with some embodiments. In some embodiments, system 100 is provided onboard an electric vehicle.

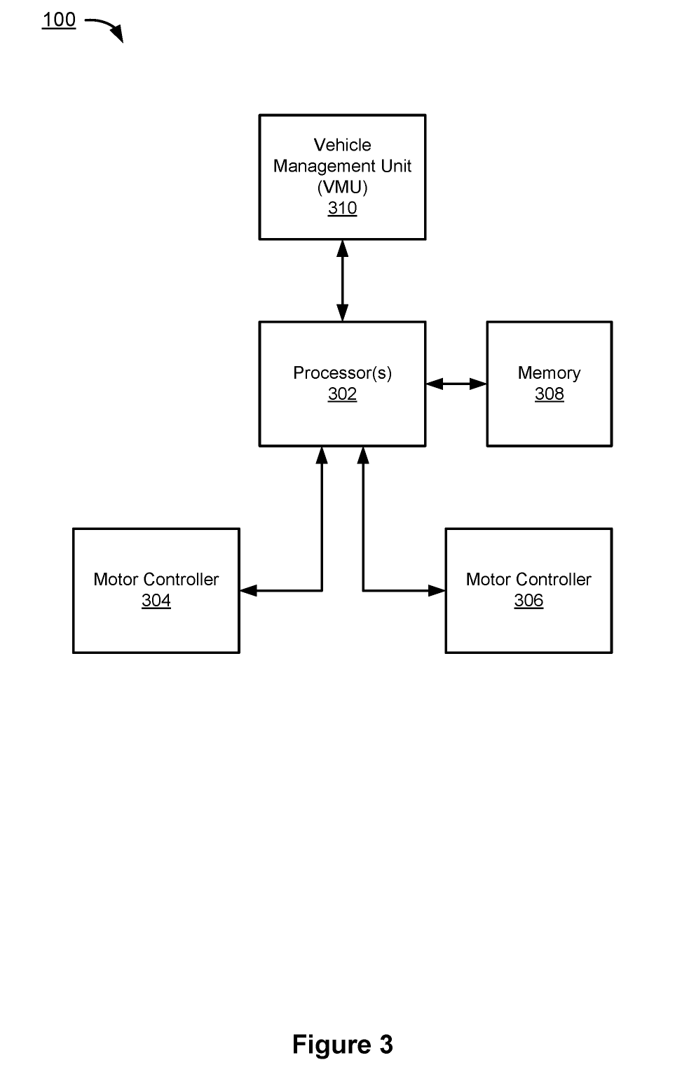

In some embodiments, system 100 includes inverter 104 (sometimes called a power inverter). In some embodiments, inverter 104 has an input terminal configured to receive DC power from a DC power source (e.g., a battery). In some embodiments, the input terminal of inverter 104 includes positive terminal 104p and negative terminal 104n. In some embodiments, inverter 104 receives DC power via terminals 104p and 104n. In some embodiments, inverter 104 converts received DC power to AC power using a plurality of switches. In some embodiments, the plurality of switches of inverter 104 are power transistors (e.g., power MOSFETs, insulated-gate bipolar transistors (IGBTs), or other device suitable for high-power switching applications). In some embodiments, system 100 includes control circuitry that controls turning on and off of the transistors (e.g., the control circuitry controls the voltages applied to the gates of the transistors) of inverter 104, as described in further detail herein with reference to FIG. 3.

In some embodiments, inverter 104 has an output terminal configured to provide AC power. In some embodiments, the output terminal of inverter 104 includes a plurality of AC terminals. Although inverter 104 is shown in FIG. 1 as a three-phase inverter, it will be readily appreciated that the inverter may, in some embodiments, have different numbers of phases (e.g., single-phase). As shown in FIG. 1, three-phase inverter 104 includes three terminals 104a, 104b, and 104c used to provide three-phase AC power. In some embodiments, inverter 104 provides, via output terminals 104a, 104b, and 104c, three-phase AC power that is converted from DC power received via input terminals 104p and 104n.

In some embodiments, the output of inverter 104 is coupled to a first motor 101. In some embodiments, motor 101 is an electric motor driven by alternating current (e.g., an AC motor, such as an induction motor). In some embodiments, as shown in FIG. 1, motor 101 includes three terminals 101a, 101b, and 101c (e.g., AC terminals). In some embodiments, terminals 101a, 101b, and 101c of motor 101 are coupled to output terminals 104a, 104b, and 104c of inverter 104, and in some such embodiments, motor 101 receives AC power from inverter 104 via the coupled terminals. In some embodiments, motor 101 is coupled to shaft 110. In some cases, when AC power is applied to motor 101 (e.g., to the AC terminals of motor 101), motor 101 applies torque to shaft 110 to rotate shaft 110.

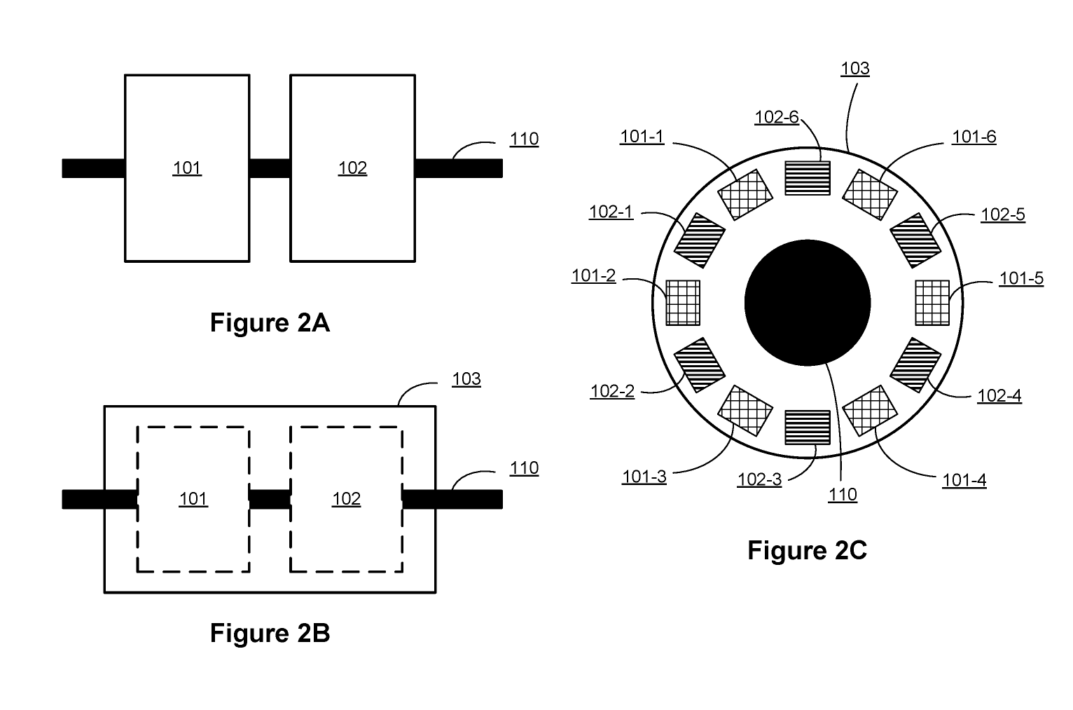

In some embodiments, system 100 includes a second motor 102. In some embodiments, motor 102 is coupled (e.g., mechanically) to motor 101. In some embodiments, motor 101 and motor 102 are distinct motors, mechanically coupled by shaft 110 (e.g., a common shaft). In some embodiments, motor 101 and motor 102 are included within a single housing. In some embodiments, motor 101 and motor 102 are respective portions of a single motor. For example, for a single motor that includes a plurality of windings, motor 101 may include a first subset of the plurality of windings, and motor 102 may include a second subset of the plurality of windings. In some embodiments, the single motor is coupled to shaft 110. Example configurations of motor 101 and motor 102 are described in further detail herein with reference to FIGS. 2A-2C.

In some embodiments, motor 102 is an AC motor. In some embodiments, as shown in FIG. 1, motor 102 includes three terminals 102a, 102b, and 102c (e.g., AC terminals). In some embodiments, motor 101 is coupled to motor 102 via shaft 110 (e.g., motor 101 and motor 102 are both coupled to shaft 110).

In some embodiments, system 100 includes clutch 120. In some embodiments, system 100 includes a plurality of wheels 122 (e.g., four wheels). In some embodiments, shaft 110 is coupled to clutch 120. In some embodiments, clutch 120 controls whether shaft 110 is coupled to or decoupled from wheels 122. For example, in some cases, shaft 110 is coupled to wheels 122 when clutch 120 is engaged, and decoupled from wheels 122 when clutch 120 is disengaged. Alternatively, or in addition, system 100 may include any other type of rotary engagement and disengagement device, such as a synchronizer, configured to control coupling or decoupling of the first motor and the second motor with the plurality of wheels.

In some cases, the rotation of shaft 110 (e.g., in response to torque applied by motor 101) produces AC power in motor 102 (e.g., motor 102 operates as a generator) which can be provided to a load via AC terminals 102a, 102b, and 102c of motor 102 (e.g., in such cases, the AC terminals of motor 102 serve as output terminals). In these cases, motor 101 is associated with torque in a first direction (e.g., positive torque) and motor 102 is associated with torque in a second direction (e.g., opposite the first direction) (e.g., negative torque).

In some cases, when AC power is applied to motor 102 (e.g., to the AC terminals of motor 102), motor 102 applies torque to shaft 110 to rotate shaft 110. In some cases, when AC power is applied to both motor 101 and motor 102, both motor 101 and motor 102 apply torque to shaft 110 to rotate shaft 110. In these cases, motor 101 and motor 102 apply torque in the same direction to shaft 110. Although motor 101 and motor 102 are shown in FIG. 1 as three-phase AC motors (e.g., driven by three-phase AC power), it will be readily appreciated that either or both motors may, in some embodiments, have different numbers of phases.

In some embodiments, motor 102 is coupled to a converter 106. In some embodiments, converter 106 includes AC terminals 106a, 106b, and 106c. In some embodiments, terminals 102a, 102b, and 102c of motor 102 are coupled to terminals 106a, 106b, and 106c of converter 106. In some embodiments, converter 106 includes DC terminals 106p and 106n. In some embodiments, positive terminal 106p and negative terminal 106n are configured to be coupled to positive and negative terminals, respectively, of a DC power source, such as a rechargeable DC power unit, optionally included as part of system 100. In some embodiments, the rechargeable DC power unit includes one or more forms of electrical energy storage, such as batteries or super capacitors. For example, as shown in FIG. 1, system 100 includes battery 108. In some embodiments, positive terminal 106p is coupled to positive terminal 108p of battery 108. In some embodiments, negative terminal 106n is coupled to negative terminal 108n of battery 108.

In some embodiments, converter 106 is a bidirectional inverter-rectifier. In some embodiments, the operation of converter 106 depends on the mode of operation of system 100. In some embodiments, converter 106 operates as an inverter (e.g., converter 106 converts AC power received using AC terminals 106a, 106b, and 106c, serving as input terminals, to DC power output that is using DC terminals 106p and 106n, serving as output terminals). In some embodiments, converter 106 operates as a rectifier (e.g., converter 106 converts DC power received using DC terminals 106p and 106n, serving as input terminals, to AC power that is output using AC terminals 106a, 106b, and 106c, serving as output terminals).

In some embodiments, converter 106 converts AC power to DC power, or DC power to AC power, using a plurality of switches. As described above with reference to inverter 104, in some embodiments, the plurality of switches of converter 106 are power transistors (e.g., power MOSFETs, insulated-gate bipolar transistors (IGBTs), or other device suitable for high-power switching applications). In some embodiments, system 100 includes control circuitry that controls turning on and off of the transistors (e.g., the control circuitry controls the voltages applied to the gates of the transistors) of converter 106, as described in further detail herein with reference to FIG. 3.

In some embodiments, system 100 includes a resolver coupled to inverter 104, converter 106, and/or shaft 110 (e.g., coupled to motor 102 and motor 102 via shaft 110), and configured to measure the rotation of motor 102 and/or motor 102. In some embodiments, system 100 includes one or more sensors to detect one or more parameters of the system (e.g., voltage, current, power, rotation, etc.)

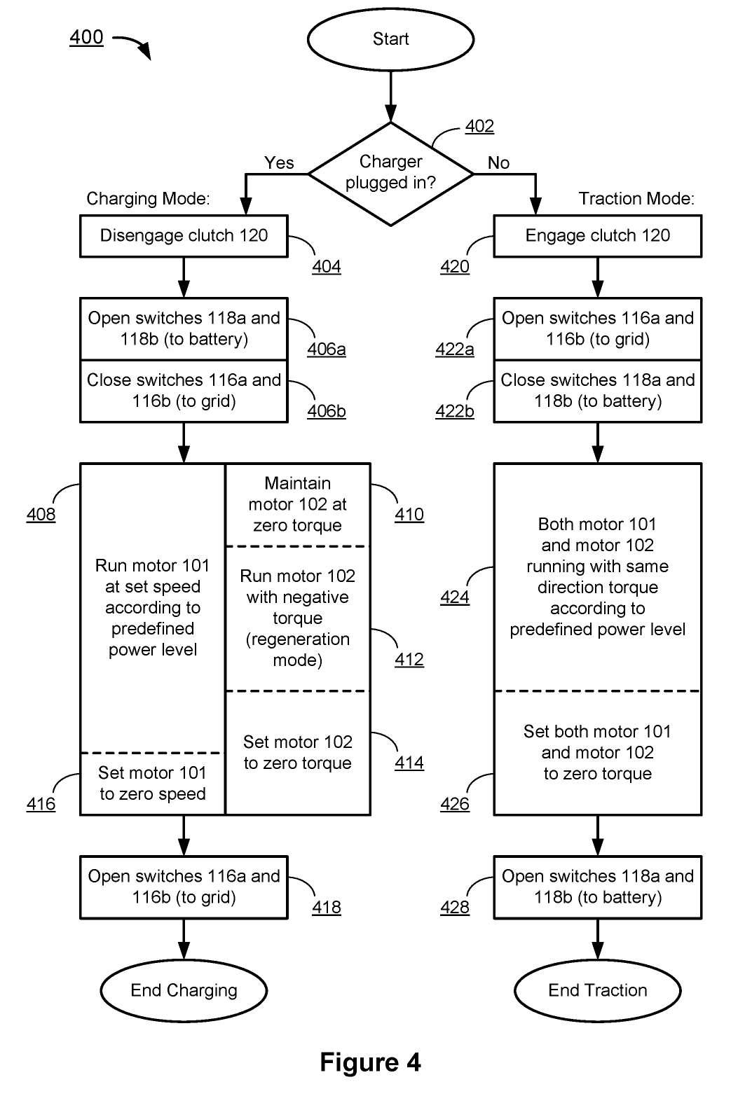

In some embodiments, system 100 includes a plurality of switches 116a, 116b, 118a and 118b. In some embodiments, each of switches 116a, 116b, 118a and 118b is configured to be in a respective switching state (e.g., open or closed). In some embodiments, switches 116a, 116b, 118a, and 118b are mechanically controlled switches (e.g., controlled by an operator of the electric vehicle on which system 100 is provided). In some embodiments, switches 116a, 116b, 118a, and 118b are electronically controlled switches (e.g., relays). In some embodiments, system 100 includes control circuitry that controls opening and closing switches 116a, 116b, 118a, and 118b (e.g., the control circuitry controls the voltages applied to the switches), as described in further detail herein with reference to FIGS. 3 and 4.

In some embodiments, closing switch 116a couples positive terminal 104p of inverter 104 to a positive terminal of a DC power source, such as positive output terminal 114p of rectifier 114. In some embodiments, closing switch 116b couples negative terminal 104n of inverter 104 to a negative terminal of the DC power source, such as negative output terminal 114n of rectifier 114. In some embodiments, system 100 includes rectifier 114 (e.g., the DC power source). In some embodiments, system 100 is configured to receive AC power (e.g., using rectifier 114) from an (external) AC power source, such as a power grid. In some embodiments, rectifier 114 includes an input terminal configured to receive AC power. In some embodiments, the input terminal of rectifier 114 includes a plurality of AC terminals. As shown in FIG. 1, rectifier 114 includes three terminals 114a, 114b, and 114c configured to receive three-phase AC power from three-phase grid 112. Three-phase grid 112 is included in FIG. 1 merely to illustrate the input power source to rectifier 114, and is not typically included as part of system 100. In some embodiments, rectifier 114 converts AC power received from three-phase grid 112 to DC power output using output terminals 114p and 114n. Although system 100 is shown in FIG. 1 as using poly-phase AC power, specifically three-phase AC power, it will be readily appreciated that system 100 may operate using AC power with different numbers of phases, including single-phase power.

In some embodiments, rectifier 114 is not part of system 100. In some such embodiments, system 100 operates as a DC-to-DC converter (e.g., DC EVSE): for example, in charging mode (described in more detail herein), system 100 receives power from an external DC power source using terminals 114p and 114n (as input terminals to system 100), at a particular input voltage, and converts the input voltage to an appropriate DC voltage for battery 108 (e.g., a DC charging voltage that complies with the specifications of battery 108).

In some embodiments, closing switch 118a couples positive terminal 104p of inverter 104 to the positive terminal 108p of battery 108. In some embodiments, closing switch 118b couples negative terminal 104n of inverter 104 to the negative terminal 108n of battery 108.

In FIG. 1, switches 116a, 116b, 118a, and 118b are illustrated as being separate from each other (e.g., single pole single throw switches). But optionally, in some embodiments, two or more of switches 116a, 116b, 118a, and 118b operate in conjunction with each other. For example, switches 116a and 116b could be implemented using a double pole single throw switch. In another example, switches 116a and 118a could be implemented using a single pole double throw switch. In yet another example, switches 116a, 116b, 118a, and 118b could all be implemented using a double pole double throw switch. Using double throw switches (e.g., for the pair 116a and 118a, and/or for the pair 116b and 118b) reduces the chance of shorting rectifier 114 to battery 108, which could cause system malfunction or even physical damage, such as when the system is coupled to a three-phase grid, and there is a mismatch between the output voltage of rectifier 114 and the DC voltage of battery 108. An advantage of using double pole switches (e.g., for the pair 116a and 116b, and/or for the pair 116b and 118b) is that both pairs of switches (e.g., the positive terminal and negative terminal) operate in conjunction with each other, simplifying the control circuitry required.

In some embodiments, the mode of operation of system 100 depends on the particular configuration of switches 116a, 116b, 118a and 118b.

In some cases, system 100 is configured to operate in charging mode (e.g., a first mode of operation). In charging mode, system 100 is configured to charge a rechargeable DC power unit (e.g., battery 108).

An example of the operation of system 100 in charging mode is described as follows. In charging mode, switches 116a and 116b are closed, so that rectifier 114 is coupled to inverter 104, and switches 118a and 118b are open, so that inverter 104 is decoupled from battery 108. Three-phase grid 112 provides AC power to the AC (input) terminals 114a, 114b, and 114c of rectifier 114. Rectifier 114 converts the AC power to DC power (e.g., rectifies the AC waveforms), and outputs the converted DC power via DC (output) terminals 114p and 114n. With switches 116a and 116b in the closed position, rectifier 114 is coupled to, and provides DC power to, inverter 104. Inverter 104 converts the DC power from rectifier 114 to AC power, and provides the converted AC power via AC (output) terminals 104a, 104b, and 104c, which are coupled to AC (input) terminals 101a, 101b, and 101c, respectively, of motor 101.

When the AC power is applied to motor 101, motor 101 applies torque to shaft 110 to rotate shaft 110. In charging mode, the rotation of shaft 110 (e.g., in response to torque applied by motor 101) produces AC power in motor 102 (e.g., motor 102 operates as a generator). The AC power produced in motor 102 is provided via AC terminals (in these cases serving as AC output terminals) 102a, 102b, and 102c of motor 102 to AC terminals (in these cases serving as AC input terminals) 106a, 106b, and 106c of converter 106. In charging mode, converter 106 converts the AC power provided from motor 102 to DC power. Converter 106 outputs the converted DC power via DC terminals (in these cases serving as DC output terminals) to DC terminals 108p and 108n of battery 108, to charge battery 108.

In some cases, system 100 is configured to operate in traction mode (sometimes called driving mode, used for driving a vehicle on which system 100 is installed) (e.g., a second mode of operation). In traction mode, system 100 is configured so that battery 108 provides power to drive motors 101 and 102 of system 100 (e.g., to propel a vehicle on which system 100 is provided). Generally, operation in traction mode discharges battery 108 (e.g., the rechargeable DC power unit).

An example of the operation of system 100 in traction mode is described as follows. In traction mode, switches 116a and 116b are open, so that rectifier 114 is decoupled from inverter 104, and switches 118a and 118b are closed, so that inverter 104 is coupled to battery 108. Battery 108 provides DC power to both inverter 104 and converter 106. In these cases, the DC terminals 106p and 106n of converter 106 serve as input terminals, and converter 106 operates as an inverter. Inverter 104 converts DC power from battery 108 to AC power to drive motor 101. Converter 106 converts DC power from battery 108 to AC power, and provides AC power via AC terminals 106a, 106b, and 106c (in these case serving as AC output terminals) to drive motor 102.

When the AC power is applied to motor 101 and motor 102, both motors apply torque to shaft 110 to rotate shaft 110. In traction mode, while clutch 120 is engaged, shaft 110 is coupled to wheels 122. In such cases, wheels 122 are rotated in conjunction with shaft 110 as shaft 110 rotates. If motor 101 and motor 102 apply torque in a first direction of torque (e.g., positive torque), while clutch 120 is engaged, the vehicle is propelled in a first direction of movement corresponding to the first direction of torque (e.g., the vehicle is propelled or accelerated forward, or backward motion of the vehicle is slowed down (e.g., braked)). If motor 101 and motor 102 apply torque in a second direction of torque (e.g., opposite the first direction of torque) (e.g., negative torque), while clutch 120 is engaged, the vehicle is propelled in a second direction of movement (e.g., opposite the first direction of movement) corresponding to the second direction of torque (e.g., the vehicle is propelled or accelerated backward, or forward motion of the vehicle is slowed down (e.g., braked)).

In some embodiments, system 100 determines whether to operate in charging mode or in traction mode. For example, in some embodiments, system 100 detects (e.g., includes control circuitry configured to detect) whether system 100 is connected to a power source (e.g., the electric vehicle on which system 100 is provided is plugged into three-phase grid 112). In some embodiments, in response to detecting that system 100 is connected to a power source, system 100 switches to the charging mode of operation. In some embodiments, in response to detecting that system 100 is disconnected to a power source, system 100 switches to the traction mode of operation. In some embodiments, the mode of operation of system 100, optionally including control of switches 116a, 116b, 118a and 118b, is determined and set by external circuitry in the vehicle on which system 100 is provided, as described in further detail herein with reference to FIGS. 3 and 4.

FIGS. 2A-2C illustrate example configurations of motors in a combined charging and traction system, in accordance with some embodiments.

FIG. 2A illustrates an example configuration in which motor 101 (FIG. 1) and motor 102 (FIG. 1) are distinct motors. Motor 101 and motor 102 are mechanically coupled with a common shaft 110. In some embodiments, motor 101 and motor 102 are each coupled with respective shafts, such that motor 101 has a first shaft, and motor 102 has a second shaft, and the first and second shaft are mechanically coupled together using an appropriate mechanical power transfer method such as gears, belts, hydraulic coupling components, chains, etc. Two motor shaft can also be mechanically coupled together with gears, belts, hydraulic, chains or other mechanical power transfer methods.

FIG. 2B illustrates an example configuration in which motor 101 and motor 102 are respective portions of a single motor 103. In some embodiments, motor 101 corresponds to a first portion of motor 103, and motor 102 corresponds to a second portion of motor 103. In some embodiments, motor 103 includes a plurality of windings, motor 101 includes a first subset of the plurality of windings, and motor 102 includes a second subset of the plurality of windings. In some embodiments, motor 103, which includes both motor 101 and motor 102, is coupled to shaft 110.

FIG. 2C illustrates an example cross section of motor 103 as described above with reference to FIG. 2B. In some embodiments, motor 103 includes a plurality of windings 101-1 through 101-6 and 102-1 through 102-6. In some embodiments, windings 101-1 through 101-6 correspond to motor 101. In some embodiments, windings 102-1 through 102-6 correspond to motor 102. In some embodiments, windings of motor 101 are alternated with windings of motor 102 in motor 103. For example, as shown in FIG. 2C, windings 101-1 through 101-6 alternate with windings 102-1 through 102-6. In some cases (e.g., charging mode), AC power applied to windings 101-1 through 101-6 cause motor 103 to apply torque to rotate shaft 110; the rotation of shaft 110 generates AC power in windings 102-1 through 102-6. In other cases (e.g., traction mode), AC power applied to windings 101-1 through 101-6 as well as to windings 102-1 through 102-6 cause motor 103 to apply torque to rotate shaft 110 using all twelve windings.

Although FIG. 2C shows twelve windings (six windings 101 and six windings 102), and shows windings 101 alternating one by one with windings 102, one of ordinary skill in the art will readily appreciate that different numbers of windings may be used, and that the windings need not alternate one by one. For example, 2 or 3 windings located together as a group is within the scope of the present application as long as they are alternated in a way with balanced load. More generally, the number of windings should be selected and the windings configured to alternate in such a way that the load on the motor and windings is balanced. For example, the windings may be alternated in groups of two (e.g., two adjacent windings 101, followed by two adjacent windings 102, followed by two more adjacent windings 101, then two more adjacent windings 102, and so on), or in groups of three (e.g., three adjacent windings 101, followed by three adjacent windings 102, and so on).

FIG. 3 is a block diagram illustrating example control circuitry in a combined charging and traction system (e.g., system 100, FIG. 1), in accordance with some embodiments. In some embodiments, system 100 (FIG. 1) includes one or more processors 302 (sometimes called CPUs, processing units, or hardware processors, and sometimes implemented using microprocessors, microcontrollers, or the like). In some embodiments, processor(s) 302 control the operation of one or more components of system 100, such as switches 116a, 116b, 118a and 118b, inverter 104 (e.g., the switching of the transistors of inverter 104), and/or converter 106 (e.g., the switching of the transistors of converter 106). In some embodiments, system 100 includes memory 308 (e.g., electrically coupled to processor(s) 302). In some embodiments, memory 308 includes a non-transitory computer readable storage medium. In some embodiments, memory 308 stores programs, modules, and data structures that provide instructions for implementing respective operations in the methods described herein with reference to FIG. 4.

In some embodiments, system 100 includes motor controller 304 and/or motor controller 306. In some embodiments, motor controller 304 is coupled to and controls the operation of motor 101 (FIGS. 1 and 2A-2C). In some embodiments, motor controller 306 is coupled to and controls the operation of motor 102 (FIGS. 1 and 2A-2C). In some embodiments, motor controller 304 and/or motor controller 306 are implemented using microprocessors, microcontrollers, or the like. In some embodiments, motor controller 304 and motor controller 306 are coupled to and communicate with processor(s) 302. In some embodiments, motor controller 304 and motor controller 306 receive instructions transmitted from processor(s) 302 (e.g., instructions for motor settings such as motor speeds, torque directions (e.g., positive or negative), and/or required power levels), and, in response, motor controller 304 and motor controller 306 control motor 101 and motor 102, respectively, according to the instructions from processor(s) 302.

In some embodiments, system 100 includes vehicle management unit (sometimes called VMU) 310. In some embodiments, VMU 310 (sometimes called an ECU or ECM) collects and analyzes information from system 100 and/or the vehicle on which system 100 is installed, and determines respective power settings (e.g., power levels) required for the charging and traction modes of operation. In some embodiments, VMU 310 is coupled to and transmits information, such as instructions, to processor(s) 302 (or to motor controllers 304 and 306 (e.g., via processor(s) 302)) for motor settings such as motor speeds, torque directions (e.g., positive or negative), and/or required power or current levels.

FIG. 4 is a conceptual flowchart representation of method 400 of controlling charging and traction in a combined charging and traction system (e.g., system 100, FIG. 1), in accordance with some embodiments. In some embodiments, method 400 is performed by system 100 (FIG. 1). In some embodiments, method 400 is performed, at least in part, by one or more processors, such as processor(s) 302 of system 100 (FIG. 3). In some embodiments, some of the operations of method 400 are performed by processor(s) 302, and other operations of method 400 are performed by other management and control units (e.g., some of the other operations of method 400 are performed by motor controller 304, motor controller 306 and/or VMU 310, FIG. 3). In some embodiments, method 400 is governed by instructions that are stored in a non-transitory computer readable storage medium (e.g., memory 308, FIG. 3) that are executed by one or more processors of a combined charging and traction system (e.g., processor(s) 302 of system 100, FIG. 3).

For ease of explanation, method 400 is described herein as being performed by system 100 (e.g., with respective operations being performed by respective components of system 100) as shown in and described herein with reference to FIGS. 1 and 3. In some embodiments, one or more operations of method 400 described below are performed in conjunction with control by an operator of the electric vehicle on which system 100 is installed.

The system determines (402) whether the system (e.g., the vehicle on which the system is installed) is connected to a charger (e.g., whether a charger is plugged in).

In accordance with a determination that the system is connected to a charger (e.g., the system is connected to an external power grid) (402—Yes), the system begins operating in charging mode. In some embodiments, although the system is connected to a charger, the system waits for a separate instruction to begin operating in charging mode (e.g., from an operator of the vehicle on which the system is installed, such as by pressing a charging button or toggling of a charging switch, or otherwise activating the charging mode). In some embodiments, the system automatically enters the charging mode in response to detecting that a charger is connected.

To operate in charging mode, the system (e.g., processor(s) 302, FIG. 3) disengages (404) clutch 120 of the vehicle (FIG. 1). In addition, the system (e.g., processor(s) 302, FIG. 3) opens (406a) switches 118a and 118b (e.g., disconnects inverter 104 from battery 108), and then closes (406b) switches 116a and 116b (e.g., connects inverter 104 to grid 112).

In charging mode, the system (e.g., motor controller 304, FIG. 3) runs (408) motor 101 (e.g., a first motor) in constant speed mode at a set speed in a first (e.g., positive) torque direction. In some embodiments, the speed at which motor 101 is run is determined in accordance with a charging power level determined by VMU 310 (FIG. 3). While running motor 101 at the set speed, the system (e.g., motor controller 306, FIG. 3) maintains (410) motor 102 (e.g., a second motor) at zero torque (e.g., initially). After maintaining motor 102 at zero torque, and while continuing to run motor 101 at the set speed, the system (e.g., motor controller 306) runs (412) motor 102 to apply negative torque (e.g., in regeneration mode, such that motor 102 operates as a generator). In some embodiments, VMU 310 determines the charging current required, and in some embodiments, the amount of negative torque from motor 102 (controlled by motor controller 306) is based on the determined charging current. In some embodiments, motor controller 304 adjusts the speed at which motor 101 is run so that the system provides the required charging current, and optionally so that the system operates more efficiently.

To finish charging mode operation, while continuing to run motor 101 at the set speed, the system (e.g., motor controller 306) sets (414) motor 102 to zero torque, and subsequently (e.g., via motor controller 304) sets (416) motor 101 to zero speed (e.g., stops motor 101). Optionally, after charging has ceased, the system (e.g., processor(s) 302) opens (418) switches 116a and 116b (e.g., disconnects inverter 104 from grid 112), in which case the system may then optionally close switches 118a and 118b (e.g., to connect inverter 104 to battery 108, such as in preparation for traction mode).

In accordance with a determination that the system is not connected to a charger (402—No), the system begins operating in traction mode. In some embodiments, the system remains in an idle mode until receiving a separate instruction to begin operating in traction mode (e.g., from an operator of the electric vehicle on which the system is installed, such as by pressing an accelerator pedal) even if the system is not connected to a charger. In some embodiments, the determination whether the system is connected to a charger is made in response to an input to the system (e.g., in response to an operator attempting to press the accelerator pedal, the system determines whether a charger is connected; if not, the system enters traction mode, but if so, the system ignores the accelerator pedal input and optionally enters or remains in charging mode).

To operate in traction mode, the system (e.g., processor(s) 302) engages (420) clutch 120 of the vehicle. In addition, the system (e.g., processor(s) 302) opens (422a) switches 116a and 116b (e.g., disconnects inverter 104 from grid 112), and then closes (422b) switches 118a and 118b (e.g., connects inverter 104 to battery 108).

In traction mode, the system runs (424) both motor 101 (e.g., the first motor) and motor 102 (e.g., the second motor) with torque in the same direction (e.g., both positive or both negative torque) (e.g., motor controller 304 runs motor 101, and motor controller 306 runs motor 102). In some embodiments, the speed, or respective speeds, at which motor 101 and motor 102 are run is determined in accordance with a traction power level determined by VMU 310. In some embodiments, motor controller 304 and motor 101 operate independently of motor 306 and motor 102, so that each motor controller-motor pair may operate with different respective torque outputs for more efficient operation (e.g., of each respective pair, and/or of the system as a whole).

To finish traction mode operation, the system sets (426) both motor 101 and motor 102 to zero torque (e.g., using motor controller 304 and motor controller 306, respectively). Optionally, after traction has ceased, the system (e.g., processor(s) 302) opens (428) switches 118a and 118b (e.g., disconnects inverter 104 from battery 108), in which case the system may then optionally close switches 116a and 116b.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of operation in an electric vehicle charging and traction system, wherein the electric vehicle charging and traction system includes:
an inverter, having an input terminal configured to receive DC power, and an output terminal configured to provide AC power;
a first motor coupled to the output terminal of the inverter;
a second motor coupled to the first motor;
a converter, having a plurality of AC terminals coupled to the second motor, and having a positive DC terminal and a negative DC terminal coupled to a rechargeable DC power unit; and
a switching mechanism configured to control coupling or decoupling of the input terminal of the inverter with at most one of a plurality of DC power sources, wherein the plurality of DC power sources includes the rechargeable DC power unit;
the method comprising:
in accordance with at least a determination that the system is coupled to a charger, operating the system in a first mode of operation, including:
decoupling the inverter from the rechargeable DC power unit, and coupling the inverter to a second DC power source of the plurality of DC power sources, via the switching mechanism;
controlling the first motor to run at a first speed in a first direction; and
while controlling the first motor to run at the first speed in the first direction:
controlling the second motor to operate with zero torque; and
after controlling the second motor to operate with zero torque, controlling the second motor to run with negative torque to generate current; and
in accordance with at least a determination that the system is decoupled from a charger, operating the system in a second mode of operation, including:
decoupling the inverter from the second DC power source, and coupling the inverter to the rechargeable DC power unit, via the switching mechanism;
controlling the first motor to operate with nonzero torque; and
controlling the second motor to operate with nonzero torque;
wherein the first motor and the second motor operate in a same torque direction.

2. The method of claim 1, including, while operating the system in the first mode of operation includes, and while controlling the first motor to run at the first speed in the first direction:
after controlling the second motor to run with negative torque, controlling the second motor so that the second motor operates with zero torque; and
after controlling the second motor so that the second motor operates with zero torque, controlling the first motor to set the speed of the first motor to zero.

3. The method of claim 2, including, after controlling the first motor to set the speed of the first motor to zero, decoupling the inverter from the second DC power source, via the switching mechanism.

4. The method of claim 1, including, while operating the system in the second mode of operation, subsequent to controlling the first motor and the second motor to operate with nonzero torque, controlling the first motor and the second motor to operate with zero torque.

5. The method of claim 4, including, subsequent to controlling the first motor and the second motor to operate with zero torque, decoupling the inverter from the rechargeable DC power unit, via the switching mechanism.

6. The method of claim 1, wherein controlling the first motor to run at a first speed in a first direction is performed in accordance with a predetermined power level.

7. The method of claim 1, wherein controlling the second motor to run with negative torque to generate current includes controlling the second motor to generate a predetermined current.
